(19) United States
(12) Patent Application Publication
(10) Pub. No.: US 2008/0312935 A1
(43) Pub. Date: Dec. 18, 2008

(54) MEDIA DEVICE WITH SPEECH RECOGNITION AND METHOD FOR USING SAME

(76) Inventor: Frederick W. Mau, II, Royal Oak, MI (US)

Correspondence Address: FREDERICK W. MAU II, 1108 ROYAL AVENUE, ROYAL OAK, MI, 48073, US

(21) Appl. No.: 12/141,342

(22) Filed: Jun. 18, 2008

Related U.S. Application Data
(60) Provisional application No. 60/944,546, filed on Jun. 18, 2007.

(51) Int. Cl. G10L 11/00

(52) U.S. Cl. 704/275; 704/E15.001

(57) ABSTRACT

A media player utilizing speech recognition software to perform functions of the media player or make file selections that may be played by the media player. The media player may include one or more microphones to receive a voice command from the user. The one or more microphones may be actuated into a state for receiving a voice command and providing the voice command to one or more microprocessors which perform a function based on the voice command.

### CROSS REFERENCE TO RELATED APPLICATIONS

This application claims priority from U.S. Provisional Patent Application Ser. No. 60/944,546, filed Jun. 18, 2007, the entire content of which is incorporated herein by reference.

### FIELD OF THE INVENTION

The present invention generally relates to media playing devices. More particularly, the present invention relates to a media playing device with speech recognition.

### BACKGROUND

Music plays an important role in everyday life for many people worldwide. People listen to music while relaxing, driving, exercising, or performing any number of activities. Portable music playing devices have been created which allow people to take music with them and listen to it wherever they like. As a result of these devices, people can listen to music while relaxing outside or while performing various activities. The portable music playing devices have evolved over the last two decades. These devices originally allowed people to listen to music stored on media such as cassettes or compact discs. Now music can be stored in electronic files such as mp3 or other type formats. These electronic music files can be stored and played on portable media players.

Portable media players have revolutionized the way people can store and enjoy music. Portable media players have the capability to store and play hundreds and thousands of songs. Songs may be uploaded and/or downloaded to and from a host device such as a desktop or laptop computer. This capability has enabled people to take with them vast music collections which they can listen to anywhere. Portable media players can be used while jogging or exercising with the use of headphones or ear pieces. Portable media players may also be used in conjunction with a home stereo system, vehicle audio system, or speakers. Many vehicles now have interfaces for portable media players, which allows them to be easily connected to the vehicle audio system.

While media players have proven to be very beneficial due to their ability to store and play large libraries of music, the selection of songs or categories of songs can be very time consuming. Songs are typically selected on the portable media player by selecting songs shown on a screen via a touch pad and/or buttons which allow the user to scroll through and select songs or categories of songs shown on a screen. Due to the number of songs available on a portable media player this process can be very time consuming. With the need to view the screen of the portable media player when selecting songs and the time needed to make such selections, the use of a portable media player may also be very distracting while performing various activities. Selecting songs or groups of song while driving can distract the vehicle operator which may lead to automobile accidents. Selecting songs while jogging or exercising may be equally dangerous as people need to pay attention to the environment around them when jogging or exercising. Recently politicians in major cities have proposed laws to prevent people from walking around in “iPod obliviousness.” As such, people typically need to stop performing whichever activity they are participating in to make song selections to minimize the risk of harming themselves or others. These problems have led to the creation of portable media players which play pre-selected playlists or shuffle songs stored therein. These functions, however, only allow users the ability to skip to the next randomly selected song or next song on a playlist instead of allowing a user to select specific songs. As such, there is a need to provide media players with the capability to quickly select songs or categories of songs which will minimize distraction to the user or the amount of time required to make song selections.

### SUMMARY OF THE INVENTION

Disclosed herein, is a media player comprising one or more microphones for receiving a voice command from the user of the media player and one or more microprocessors in communication with said one or more microphones. At least one of the microprocessors utilizing speech recognition software to convert the voice command received from the user into a signal recognized by the media player. The signal recognized by the media player causing the media player to perform a function or make a selection of one or more files stored therein based on the voice command. The one or more microphones may be actuated into a state for receiving the voice command and communicating the voice command to the one or more microprocessors via an actuating mechanism operable by the user.

The one or more microphones may be integrated into the media player, worn by the user of the media player, integrated into earphones used in conjunction with the media player, or integrated into an article worn by the user of the media player. The one or more microphones may be external to the media player. The one or more external microphones may be in communication with the media player via a wireless connection or a wire connection.

The actuating mechanism may be a push button actuator. The push button may be integral with the media player or external to the media player. The actuating mechanism may actuate the one or more microphones upon receipt of a voice command having an amplitude above a predetermined level by one or more of the microphones. The actuating mechanism may have the sole function of actuating the one or more microphones into a state for receiving said voice command and communicating said voice command to said one or more microprocessors.

The media player may also comprise an output for providing an audible or visual signal to the user based on said voice command. The audible or visual signal may prompt the user to input information via a voice command.

The media player also comprises a source of memory. The source of memory may have a set of words, phrases or phonemes stored therein and used by the speech recognition software to perform a function or make a selection based on the voice command. The source of memory may be configured to receive and store new words, phrases, or phonemes from the user. The new words, phrases, or phonemes may be assigned to a specific selection or function by the user.

Also disclosed herein is a method for operating a media player. The method comprises the steps of providing a first voice command relating to a function of the media player or a selection of one or more files stored within the media player; receiving the voice command via one or more microphones; processing the voice command into a signal recognized by the media player via speech recognition software; and performing the function or making the selection on the media player via recognition of the signal by said media player.

The method may further comprise the step of prompting the user for additional information in relation to the first voice command upon processing the first voice command. The user may provide a second voice command in response to prompting of the user, the second voice command providing additional information to the media player to narrow a group of media selections.

The step of processing the voice command may comprise the steps of converting the voice command into a series of digitized frequencies; comparing the series of digitized frequencies to a stored set of words, phrases, or phonemes; selecting the word, phrase, or phoneme matching the series of digitized frequencies; performing a function or making a selection based on the signal assigned to the word, phrase, or phoneme matched to the series of digitized frequencies. One or more of the stored set of words, phrases, or phonemes may be input into the memory of the media player and assigned to a specific function or selection by the user.

### BRIEF DESCRIPTION OF THE DRAWINGS

FIG. 1, is a depiction of a media player in accordance with the present invention.

FIG. 2, is a depiction of a media player in accordance with the present invention having one or microphones incorporated into headphones or earphones which are used with the media player.

FIG. 3, is a depiction of a media player in accordance with the present invention having one or more microphones for receiving a voice command integrated with an article worn by the user.

FIG. 4, is a depiction of a media player in accordance with the present invention connected to an aftermarket device for receiving a voice command and communicating the voice command to the media player.

### DETAILED DESCRIPTION OF THE PREFERRED EMBODIMENTS OF THE INVENTION

A media player is a device which stores and plays various types of content such as music, video, and/or pictures. A well known example of a typical media player is the iPod® sold by Apple Computers, Inc. Content stored on media players may be provided to a user via a display screen and/or speakers integrated with or in communication with the media player. Media players are typically portable devices that a user may carry with them. Most media players are pocket size which allows a user to carry and use the media player while performing a variety of activities.

In accordance with the present invention there is provided a media player which provides for the selection of songs, menus, and/or functions associated therewith based on recognition of voice commands supplied from the user. By providing for song, menu, and/or function selection via voice commands, the amount of time required by the user to navigate through a vast music/media library may be substantially minimized. The media player provides the user with the ability to quickly select a song, group of songs, menus, or perform various functions of the media player without needing to view the screen of the media player and make selections with one or more buttons and/or a touch pad. Furthermore, the use of voice commands to select and play songs and groups of songs allows the user to use the media player while performing activities such as driving or exercising with minimal distraction. While the media player in accordance with the present invention relates mainly to the selection of songs, the same may be used for the selection of video or picture files based on voice commands.

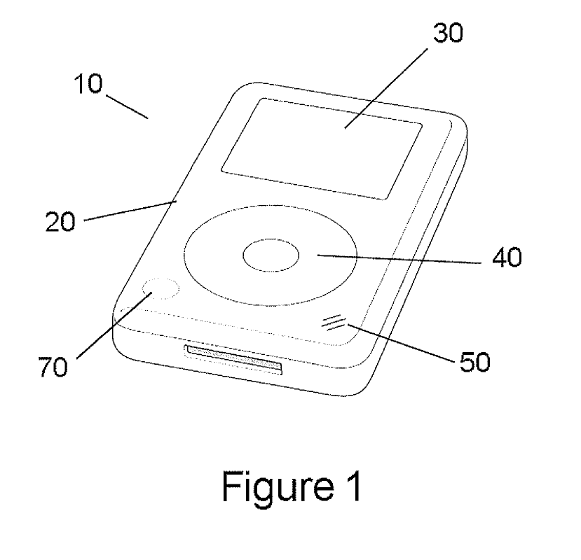

As depicted in FIG. 1, the media player 10 generally comprises a housing 20 with various electronic components disposed therein, the electronic components providing computing operations for the media player. The electronic components may generally include one or more microprocessors, memory (e.g., ROM, RAM), a power supply (e.g., rechargeable battery), a circuit board, a hard drive, and various input/output (I/O) support circuitry. The electrical components may include components for outputting music such as an amplifier and a digital signal processor. The media player 10 may also include a display screen 30. The display screen 30 may be used to display a graphical user interface as well as other information to the user (e.g., text, objects, graphics). The display screen may be a liquid crystal display or any other type display screen which may be incorporated into and used within the media player. The media player may include control means 40 for controlling one or more functions/applications of the media player. The control means may include one or more buttons, a touch pad, a scrolling dial or any combination thereof. The control means may be used to make a song selection, scroll through a song library, control volume, and/or perform various tasks (e.g., play, pause, rewind, fast forward) associated with playing a media file.

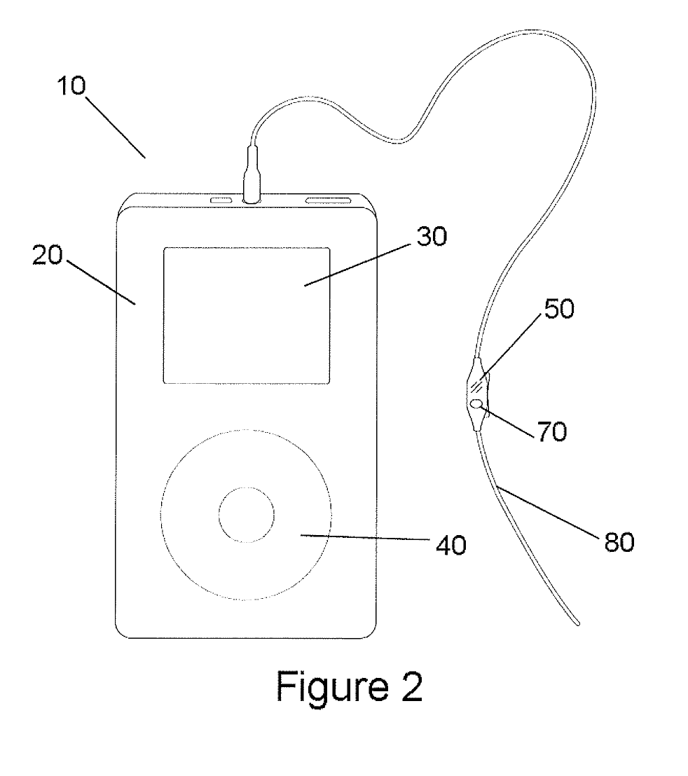

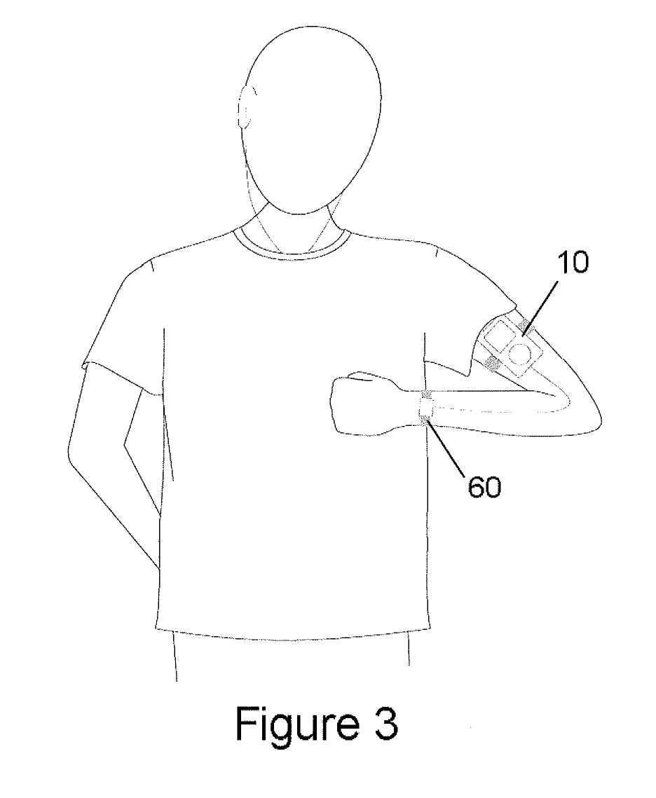

The media player may also comprise one or more microphones 50 for receiving a voice command from the user. The one or microphones 50 may be incorporated at various locations within the media player provided the one or more microphones are able to receive a voice command from the user. Alternatively, the media player may interface with one or more external microphones which are in communication with the media player via a wire connection or a wireless connection (e.g., bluetooth). When external to the media player, the one or more microphones 50 may be incorporated into headphones or earphones which are used with the media player as depicted in FIG. 2. The one or more microphones may be located on the wire 80 connecting the headphones/earphones to the media player or may be integrated into one or both of the earpieces. The headphones or earphones may be connected to the media player via a wire connection or may be in communication with the media player via a wireless connection. The microphone may also be clipped onto an article of clothing (e.g., shirt, jacket, hat) being worn by the user such that the microphone may receive voice commands from the user. The one or more microphones may also be integrated with an article 60 (e.g., wristband, jewelry, glasses, hat) that may be worn by the user as depicted in FIG. 3.

The microphone may utilize an actuating mechanism 70 to actuate the microphone so that the microphone may receive a voice command. The actuating mechanism 70 may be a button, switch, touch pad, sensor, touch screen, or any other type of mechanism that may turn the microphone from a normally off state to an on state, wherein the one or more microphones are placed into a state for receiving a voice command from the user and communicating the voice command to the one or more microprocessors. By being in a normally off state, the microphone will not detect background noise or conversation which may be mistaken for a voice command. Upon actuation of the actuating mechanism, the microphone is actuated into a state for receiving the voice command from the user and communicating the voice command to the one or more microprocessors. The one or more microphones may only be turned on for a short period of time, for example less than 10 seconds. The actuating mechanism 70 may be incorporated into and integral with the media player as depicted in FIG. 1 or may be external to the media player as depicted in FIGS. 2 and 3. When external to the media player, the signal resulting from actuation of the actuating mechanism may be transmitted to the microphone via a wire connection or a wireless connection. The actuating mechanism 70 may be integrated with or in close proximity to the one or more microphones 50. Similar to the one or more microphones, the actuating mechanism may be worn by the user or clipped to a garment worn by the user. For example, the actuating mechanism may be included in a wrist band proximate to the microphone thereby allowing the user to actuate the actuating mechanism and immediately speak a voice command into the microphone as depicted in FIG. 3. While it is preferable that the microphone remains in a normally off state, a microphone as used with the present invention may also remain in an on state during use of the media player. This will allow the user to simply speak a voice command into the microphone at any given time and have the command performed by the media player. The actuating mechanism may have the sole function of actuating the one or more microphones into a state for receiving said voice command and communicating said voice command to said one or more microprocessors. Having an actuating mechanism with the sole function of actuating the one or more microphones may require a control separate from the normal controls of the media player. Having a separate control for actuating the one or more microphones will provide for simplified input of the voice command into the media player. For example, a user will not have to navigate one or more menu screens on the media player or make multiple selections to input a voice command the to media player.

An alternative to including a physically actuated mechanism is to utilize an actuating mechanism which actuates the one or more microphones into an on state upon receipt of a voice command by the one or more microphones which exceeds a predetermined amplitude. This will prevent background noise or conversation noise from being received by the microphone which may result in a false command being transmitted to the media player. The predetermined amplitude may be increased or decreased by the user to accommodate the user's preferences.

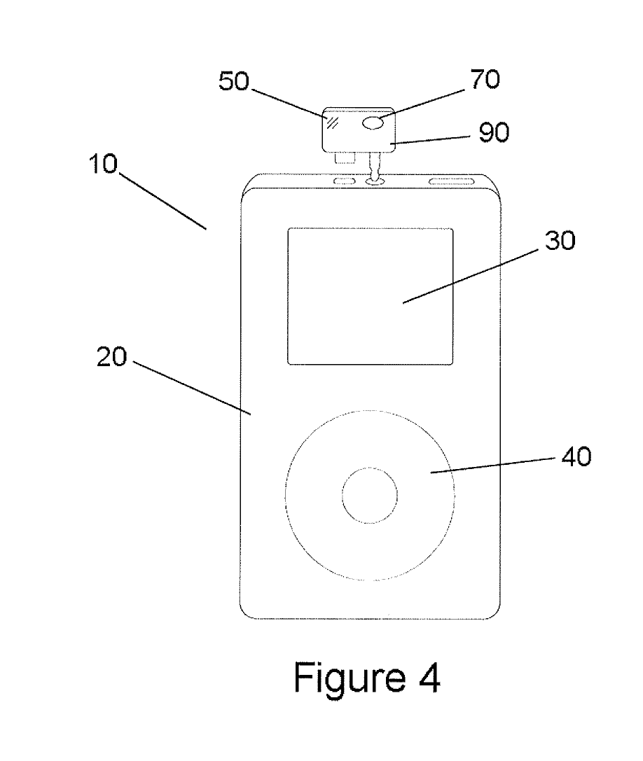

To process the voice signal received by the one or more microphones and communicated to the media player, one or more of the microprocessors within the media player utilize speech recognition software. The microprocessors may be included within the media player or included in an aftermarket device with one or more microphones and an actuating mechanism which is connected to the media player. A depiction of such an aftermarket device 90 is shown in FIG. 4. The speech recognition software generally utilizes an algorithm to convert a speech signal to a sequence of words or a command which may be recognized by the media player. Various types of speech recognition software are available and may be used in conjunction with the media player disclosed herein. The speech recognition software may be based off of a Hidden Markov model-based speech recognition system, a neural network-based speech recognition system, or dynamic time warping-based speech recognition system. The type of speech recognition system may be selected based on the needs of the media player. Such needs that may be taken into account include scalability, cost, and accuracy.

When a device is equipped with speech recognition software, various device functions or selections may be performed by speaking voice commands into a microphone in communication with the device. The speech recognition software converts the spoken command into a series of digitized frequencies, which are compared to a stored set of words, phrases, or phonemes. When the computer determines correct matches for the series of frequencies, computer recognition of that portion of human speech is accomplished. The frequency matches are compiled until sufficient information is collected for the computer to determine which function is to be performed or what selection is to be made. The device can then react to certain spoken commands by performing the one or more functions or making the one or more selections associated with the spoken commands. When the matches are unsatisfactory for the system to conclusively determine between a small number of remaining possibilities, a reduced menu of the possibilities may be offered verbally by the media player as suggestions. The suggestions may be numbered to permit the speech recognition system to make an easier differentiation between the remaining choices.

As discussed previously, speech recognition software compares digitized versions of spoken commands to previously stored sets of words, phrases, or phonemes which may stored within the media player memory. In media selections, such as songs, the title of the songs or name of the artists may be complex or not included in typical databases or words, phrases or phonemes that may be provided for comparison. In the case of a particular word or phrase not being included in the stored set of words, phrases or phonemes, the media player may also allow the user to record a word or phrase that may be associated with a particular song, artist, genre, album, or playlist. The word or phrase may be added to the stored set of words, phrases or phonemes within the media player and will allow the user to make a selection of a song or groups of songs associated with the word or phrase.

During operation of the media player, a voice command is given by the user and received by the one or more microphones. The voice command may be a specific command function such as play, stop, pause, skip, next song, previous song, random, repeat, or power off. The voice command may also relate to the selection of a song or group of songs. In such case, the voice command may be a word or phrase such as “select song”, “select playlist”, “select artist”, “select genre”, “select album” etc. Upon receipt and recognition of the voice command the media player may prompt the user via an audible and/or visual signal to input further information such that additional voice commands may be input by the user. Upon inputting a voice command such as “select song”, the media player may then prompt the user to input the song name. Similar prompts may be used with other voice commands as listed above. The media player may also prompt the user to select from one or more songs having a similar name. The media player may continue to prompt the user until the selection has been narrowed down to one selection or a group of selections. For instance, a user may input the voice command “select artist”. The media player would then prompt the user to input the artist name. Upon recognition of the artist name, the media player may prompt the user for additional information so that the list of songs by a particular artist may be narrowed. Upon receiving the prompt, the user may select a certain song, play the entire list in order, or randomly play songs from the list based on voice commands.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

1. A media player comprising:
one or more microphones for receiving a voice command from the user of said media player; and
one or more microprocessors in communication with said one or more microphones, at least one of said microprocessors utilizing speech recognition software to convert said voice command into a signal recognized by said media player, said signal causing said media player to perform a function or make a selection of one or more files based on said voice command;
said one or more microphones being actuated into a state for receiving said voice command and communicating said voice command to said one or more microprocessors via an actuating mechanism operable by the user.

2. The media player according to claim 1, wherein said one or more microphones are integrated into said media player.

3. The media player according to claim 1, wherein said one or more microphones are worn by the user of said media player.

4. The media player according to claim 1, wherein said one or more microphones are integrated into earphones receiving said audible signal firm said media player.

5. The media player according to claim 1, wherein said one or more microphones are integrated into an article worn by the user of said media player.

6. The media player according to claim 1, wherein said one or more microphones are external to said medial player, said one or more microphones being in communication with said media player via a wireless connection.

7. The media player according to claim 1, wherein said actuating mechanism is a push button actuator.

8. The media player according to claim 7, wherein said push button is integral with said media player.

9. The media player according to claim 7, wherein said push button is external to said media player.

10. The media player according to claim 1, wherein said actuating mechanism actuates said one or more microphones upon receipt of a voice command having an amplitude above a predetermined level by one or more of said microphones.

11. The media player according to claim 1, wherein said actuating mechanism has the sole function of actuating said one or more microphones into a state for receiving said voice command and communicating said voice command to said one or more microprocessors.

12. The media player according to claim 1, further comprising an output for providing an audible or visual signal to the user based on said voice command.

13. The media player according to claim 12, wherein said audible or visual signal prompts the user to input information via a voice command.

14. The media player according to claim 1, further comprising a source of memory having a set of words, phrases or phonemes stored therein, said set of words, phrases, or phonemes being used by said speech recognition software to perform a function or make a selection based on said voice command.

15. The media player according to claim 14, wherein said source of memory is configured to receive and store new words, phrases, or phonemes from the user, said new words, phrases, or phonemes being assigned to a specific selection or function by the user.

16. A method for operating a media players said method comprising the steps of:
providing a first voice command relating to a function of said media player or a selection of one or more files stored within said media player;
receiving said first voice command via one or more microphones;
processing said first voice command into a signal recognized by said media player via speech recognition software; and
performing said function or making said selection on said media player via recognition of said signal by said media player.

17. The method according to claim 16, further comprising the step of prompting the user for additional information in relation to said first voice command upon processing said first voice command.

18. The method according to claim 17, wherein the user provides a second voice command in response to prompting of the user, the second voice command providing additional information to the media player to narrow a group of media selections.

19. The method according to claim 16, wherein said step of processing said voice command comprises the steps of:
converting said first voice command into a series of digitized frequencies;
comparing said series of digitized frequencies to a stored set of words, phrases, or phonemes;
selecting the word, phrase, or phoneme matching said series of digitized frequencies; and
performing a function or making a selection based on said signal assigned to the word, phrase, or phoneme snatched to said series of digitized frequencies.

20. The method according to claim 19, wherein one or more of said stored set of words, phrases, or phonemes is input into the memory of said media player and assigned to a specific function or selection by said user.
